(19) United States
(12) Patent Application Publication
(10) Pub. No.: US 2026/0155470 A1
(43) Pub. Date: Jun. 4, 2026

(54) PROCESS AND DEVICE FOR PRODUCING COPPER COMPOSITE MATERIAL

(71) Applicant: BASF SE, Ludwigshafen am Rhein (DE)

(72) Inventors: Marc DUCHARDT, Ludwigshafen (DE); Andreas Michael KERN, Ludwigshafen (DE); Tobias ELWERT, Schwarzheide (DE); Birgit GERKE, Ludwigshafen (DE); Karl HOELEMANN, Ludwigshafen (DE); Wolfgang ROHDE, Ludwigshafen (DE); Regina VOGELSANG, Ludwigshafen (DE); Wolfram WILK, Ludwigshafen (DE); Tobias UHLIG, Schwarzheide (DE); Kerstin SCHIERLE-ARNDT, Ludwigshafen (DE); Nils-Olof Joachim BORN, Ludwigshafen (DE); Fabian SEELER, Ludwigshafen (DE); Anne-Marie Caroline ZIESCHANG, Ludwigshafen (DE)

(21) Appl. No.: 19/122,956

(22) PCT Filed: Oct. 31, 2023
(86) PCT No.: PCT/EP23/80410

§ 371 Date: Apr. 21, 2025

(30) Foreign Application Priority Data
Nov. 3, 2022 (EP) 22205377.9

(51) Int. Cl. H01M 10/54; C22B 1/24; C22B 15/00

(52) U.S. Cl. CPC H01M 10/54; C22B 15/0056; C22B 1/24

(57) ABSTRACT

Disclosed herein are a process and a device for producing a copper composite material including copper and carbon, such as graphite, and having improved processibility and/or metal recovery in processes for recycling and/or recovery of valuable metals. The composite material is a useful intermediate in the recycling of lithium ion batteries.

### FIELD OF THE INVENTION

Disclosed are a process and a device for producing a copper composite material comprising copper and carbon, e.g., graphite, and having improved processibility and/or metal recovery in processes for recycling and/or recovery of valuable metals. The composite material is a useful intermediate in the recycling of lithium ion batteries.

### BACKGROUND

Lithium ion battery materials are complex mixtures of various elements and compounds. For example, many lithium ion battery materials contain valuable metals such as lithium, aluminum, copper, nickel, cobalt, and/or manganese. It may be desirable to recover various elements and compounds from lithium ion battery materials. For example, it may be advantageous to recover lithium, aluminum, copper, nickel, cobalt, and/or manganese. In some battery recycling processes, different process parameters may produce intermediate materials having different compositions and/or properties. Intermediate materials having, for example, a favorable composition, mechanical properties, surface hydrophilicity, and/or porosity may, e.g., result in improved processibility and/or recovery in subsequent downstream processing steps. Such downstream processing steps may, for example, be part of a lithium ion battery recycling process and/or more general metal recycling and/or recovering steps.

Accordingly, there is a need for materials having improved processibility and/or metal recovery in subsequent downstream recycling and/or recovery processes. For example, there is a need for intermediate lithium ion battery recycling materials having, for example, a favorable composition, mechanical properties, surface hydrophilicity, and/or porosity. Further, there is a need for improved battery recycling processes for producing such improved intermediate materials. Copper is a very valuable part of spent lithium ion batteries and therefore there is a need for revovering it during battery recycling.

EP 3 576 216 A1 discloses a method for recovering valuable materials from lithium-ion batteries which includes a discharge step of discharging a lithium-ion battery; a thermal decomposition step of reducing a lithium compound, which is a cathode active material, into a magnetic oxide by thermally treating the lithium-ion battery after being discharged; a crushing step of crushing the lithium-ion battery, after being thermally decomposed, into fragments of a size suitable for wind sorting, allowing part of the magnetic oxide to remain in the aluminum foil; a sieving step of sieving a crushed material to separate the crushed material into an oversized product and an undersized product; a wind sorting step of separating the oversized product into a heavy product and a light product; and a magnetic sorting step of sorting and recovering the aluminum foil with a residue of the magnetic oxide, as a magnetized material, and recovering the copper foil as a non-magnetized material from the light product.

LOMBARDO, Gabriele et al.: “Chemical Transformations in Li-Ion Battery Electrode Materials by Carbothermic Reduction”, ACS SUSTAINABLE CHEMISTRY & ENGINEERING, vol. 7, no. 16 (2019) pp. 13668-13679 relates to the effects of pyrolysis om the composition of battery cell materials as a function of treatment time and temperature. Waste of Li-ion batteries was pyrolyzed in a nitrogen atmosphere at 400, 500, 600, and 700° C. for 30, 60, and 90 min. Treatment of a mix of cathodes and anodes of an NMC Li-ion battery at a temperature between 40° and 700° C. triggers a carbothermic reduction of the cathode active material, and Co, Mn, and Ni are obtained in a lower oxidation state.

EP 3 702 481 A1 discloses a method for separating copper from nickel and cobalt from an alloy including copper, nickel, and cobalt obtained by dry treatment of waste lithium ion cells. An alloy including copper, nickel, and cobalt is brought into contact with sulfuric acid in the joint presence of a sulfurizing agent, and a solid containing copper and a leachate containing nickel and cobalt are obtained.

### SUMMARY OF THE INVENTION

Disclosed is a process for producing a copper composite material comprising copper and carbon, e.g., graphite, and having improved processibility and/or metal recovery in processes for recycling and/or recovery of copper. The process comprises heating lithium ion battery recycling material to a temperature of from 400° C. to 630° C. while contacting the material with an inert gas and with a reductive gas generated in situ by thermal decomposition of the material to obtain a pyrolyzed lithium ion battery recycling material. The process also comprises comminuting the lithium ion battery recycling material prior to the heating step and/or comminuting the pyrolyzed lithium ion battery recycling material subsequent to the heating step, and separating the copper composite material from the comminuted and pyrolyzed lithium ion battery recycling material.

A device for producing the copper composite material also is disclosed. The device comprises at least two comminuting devices, a pyrolysis device, and at least one separating device configured to separate the copper composite material from comminuted and pyrolyzed lithium ion battery recycling material.

Further, the use of the copper composite material in the recovery of copper from lithium ion batteries is provided.

### Definitions

As used herein, the term “composite material” refers to a material comprising two or more different constituents.

As used herein, the term “lithium ion battery recycling material” refers to a material comprising lithium ion batteries or battery scrap which comprise a copper foil coated with carbon, e.g., graphite coated on the surface of the copper foil.

The term “comminute” is used herein to describe any mechanical treatment of material in or by any suitable comminuting device. Examples of suitable comminuting devices include shredders, such as a 4-shaft shredder, a 2-shaft shredder, and a 1-shaft shredder, and/or mills, such as a balling mill, a cutter mill, a jet mill, and an impact mill, particularly, a rotor impact mill.

The term “separating device” is used herein for any kind of device suitable to divide battery material particles into different fractions. Examples of suitable separating devices include sieving/screening devices such as vibratory or tumbler screeners, zig-zag classifiers, separating tables, air jigs, fluid bed separators, eddy current separators, electrostatic separators, magnetic separators, and any combination thereof.

### DETAILED DESCRIPTION

### Copper Composite Material

The copper composite material of the present disclosure comprises copper and carbon, e.g., graphite. In some embodiments, the copper composite comprises from 0.1 to 20 wt.-% carbon, based on the total weight of the copper composite material. In some embodiments, the copper composite comprises from 0.5 to 15 wt.-%, for instance, from 1 to 5 wt.-% carbon, based on the total weight of the copper composite material.

In some embodiments, the copper composite material of the present disclosure comprises from 80 wt.-% to 99.9 wt.-%, e.g., from 85.0 to 95.5 wt.-%, for instance, from 88.0 wt.-% to 93 wt.-% copper, based on the total weight of the copper composite material.

In some embodiments, the copper composite material of the present disclosure comprises from 0.04 wt.-% to 2.0 wt.-%, e.g., 0.05 to 1.0 wt.-% lithium, based on the total weight of the copper composite material.

In some embodiments, the copper composite material of the present disclosure comprises from 0.001 wt.-% to 3.0 wt.-%, e.g., from 0.003 wt.-% to 0.08 wt.-% nickel, based on the total weight of the copper composite material.

In some embodiments, the copper composite material of the present disclosure comprises from 0.001 wt.-% to 0.08 wt.-%, e.g., from 0,002 wt.-% to 0.004 wt.-% chromium, based on the total weight of the copper composite material.

In some embodiments, the copper composite material of the present disclosure comprises from 0.001 wt.-% to 0.01 wt.-%, e.g., from 0.001 to 0.006 wt.-% iron, based on the total weight of the copper composite material.

In some embodiments, the copper composite material of the present disclosure comprises from 0.001 wt.-% to 1.0 wt.-%, e.g., from 0.03 wt.-% to 0.15 wt.-% cobalt, based on the total weight of the copper composite material.

In some embodiments, the copper composite material of the present disclosure comprises from 0.001 wt.-% to 0.5 wt.-%, e.g., from 0.14 wt.-% to 0.25 wt.-% manganese, based on the total weight of the copper composite material.

In some embodiments, the copper composite material of the present disclosure comprises from 0.001 wt.-% to 2.0 wt.-%, e.g., from 0.38 wt.-% to 0.75 wt.-% aluminum, based on the total weight of the copper composite material.

In some embodiments, the copper composite material of the present disclosure comprises from 0.001 wt.-% to 0.005 wt.-%, e.g., from 0.001 wt.-% to 0.002 wt.-% magnesium, based on the total weight of the copper composite material.

In some embodiments, the copper composite material of the present disclosure takes the form of a plurality of individual particles. In some embodiments, the particle diameter of the particles of the copper composite material, measured by sieve analysis according to DIN 66165, is not larger than 500 μm, e.g., not larger than 250 μm.

### Process for Preparing Copper Composite Materials

The present disclosure provides a process for preparing the copper composite material. The process comprises
a) providing a lithium ion battery recycling material comprising a copper foil having graphite coated on the surface of the copper foil;
b) heating the lithium ion battery recycling material to a temperature of from 400° C. to 630° C. while contacting the lithium ion battery recycling material with an inert gas and with a reductive gas generated in situ by thermal decomposition of the lithium ion battery recycling material to obtain a pyrolyzed lithium ion battery recycling material;
c) comminuting the lithium ion battery recycling material prior to step b) and/or comminuting the pyrolyzed lithium ion battery recycling material subsequent to step b) to produce a fine fraction consisting of particles having a particle size <500 μm;
d) separating the copper composite material from the comminuted and pyrolyzed lithium ion battery recycling material fine fraction consisting of particles having a particle size <500 μm.

The process of the present description involves heating the lithium ion battery recycling material to a temperature of from 400° C. to 630° C. while contacting the lithium ion battery recycling material with an inert gas and with a reductive gas generated in situ by thermal decomposition of the lithium ion battery recycling material.

In some embodiments, the process of the present disclosure comprises providing the lithium ion battery recycling material at a first temperature; heating the the lithium ion battery recycling material at a second temperature ranging from 400° C. to 630° C., e.g, from 520° C. to 630° C., for instance, from 550° C. to 600° C.; contacting the the lithium ion battery recycling material with an inert gas and with a reductive gas generated in situ by thermal decomposition of the the lithium ion battery recycling material to obtain a pyrolyzed lithium ion battery recycling material; and optionally cooling the pyrolyzed lithium ion battery recycling material to a third temperature ranging from 10° C. to 100° C., e.g., from 20° C. to 70° C.

In some embodiments, the process of the present disclosure comprises providing the lithium ion battery recycling material at a first temperature. In some embodiments of the process, the first temperature ranges from −50° C. to 50° C., e.g., from −10° C. to 40° C., for instance, from 0° C. to 30° C. In a particular embodiment, the first temperature is ambient temperature.

In some embodiments, the process of the present disclosure comprises heating the lithium ion battery recycling material at a second temperature ranging from 400° C. to 630° C., e.g., from 520° C. to 630° C. In some embodiments of the process, the second temperature ranges from 530° C. to 600° C. In further embodiments, the second temperature ranges from 550° C. to 580° C.

In some embodiments of the process, the heating step comprises a temperature ramp from the first temperature to the second temperature over a period of 10 minutes to 2 hours. In some embodiments of the process, the heating step comprises a temperature ramp from the first temperature to the second temperature over a period of 30 minutes to 1 hour.

In some embodiments, a temperature ramp has average rate of temperature increase of at least 5 K per minute. In some embodiments, a temperature ramp has average rate of temperature increase of at least 10 K per minute. In some embodiments, a temperature ramp has average rate of temperature increase of at least 15 K per minute. In some embodiments, a temperature ramp has average rate of temperature increase of at least 20 K per minute. In some embodiments, a temperature ramp has average rate of temperature increase of at least 25 K per minute. In some embodiments, a temperature ramp has average rate of temperature increase of up to 50 K per minute.

In some embodiments, a temperature ramp has average rate of temperature increase ranging from 5 K per minute to 50 K per minute. In some embodiments, a temperature ramp has average rate of temperature increase ranging from 10 K per minute to 50 K per minute.

In some embodiments of the process, the heating step comprises dwelling at the second temperature for a period of time ranging from 0 minutes to 1 hour, for instance, from 10 minutes to 45 minutes, or from 15 minutes to 30 minutes.

In some embodiments of the process, the heating step comprises dwelling at one or more intermediate temperatures ranging from the first temperature to the second temperature.

In some embodiments, the process of the present disclosure comprises: providing the lithium ion battery recycling material at a first temperature ranging from −50° C. to 50° C.; heating the lithium ion battery recycling material at a second temperature ranging from 520° C. to 600° C.; wherein the heating step comprises a temperature ramp from the first temperature to the second temperature over a period of time ranging from 10 minutes to 1 hour; dwelling at the second temperature for a time ranging from 0 minutes to 1 hour; and, optionally, cooling the material to a third temperature ranging from 50° C. to 70° C.

In some embodiments, the process of the present disclosure comprises contacting the lithium ion battery recycling material with an inert gas and with a reductive gas generated in situ by thermal decomposition of the lithium ion battery recycling material to obtain a pyrolyzed lithium ion battery recycling material.

In some embodiments, the flow rate of the inert gas is in the range of from 100 to 300 Sm³/h, e.g. 150 to 250 Sm³, for instance, 200 Sm³/h (standard cubic metre per hour).

In some embodiments, the inert gas comprises at least one gas chosen from argon (Ar), dinitrogen (N₂), helium (He), and mixtures thereof.

In some embodiments, the reductive gas comprises at least one gas chosen from the group of hydrocarbons, dihydrogen gas (H₂), carbon monoxide (CO), and mixtures thereof.

In some embodiments of the process, the reductive gas comprises: from 5 volume % to 70 volume % C₁ to C₁₀ hydrocarbons, from 5 volume % to 95 volume % carbon dioxide (CO₂), from 0.1 volume % to 10 volume % carbon monoxide (CO), and from 0.1 volume % to 15 volume % H₂; wherein each volume % is by total volume of the reductive gas and the volume % of C₁ to C₁₀ hydrocarbons plus the volume % of CO₂ plus the volume % of H₂ is less than or equal to 100%.

In some embodiments of the process, the reductive gas comprises: from 5 volume % to 70 volume % C₁ to C₁₀ hydrocarbons, from 5 volume % to 45 volume % C₁ to C₁₀ oxy-hydrocarbons, and from 0.1 volume % to 15 volume % H₂; wherein each volume % is by total volume of the reductive gas and the volume % of C₁ to C₁₀ hydrocarbons plus the volume % C₁ to C₁₀ oxy-hydrocarbons plus the volume % of H₂ is less than or equal to 100%.

In some embodiments of the process, the heating step is performed in a rotary kiln. In some embodiments of the process, the kiln is filled with a volume of lithium ion battery recycling material equal to 5 to 20%, e.g., from 7% to 16%, for instance, from 9% to 12%, of the total volume of the kiln.

In some embodiments of the process, the lithium ion battery recycling material is fed to the kiln using at least one screw conveyor.

In some embodiments of the process, the kiln rotates at 0.5 to 3 rpm. In some embodiments of the process, the kiln rotates at 1.4 to 2.6 rpm. In some embodiments of the process, the kiln rotates at 1.8 to 2.2 rpm.

In some embodiments of the process, overpressure is maintained in the kiln during operation to prevent air from entering the kiln.

In some embodiments of the process, hot gases pass along the kiln in the same direction as the process material (concurrent). In some embodiments of the process, the lithium ion battery recycling material and an inert gas are fed to the rotary kiln in concurrent flow. The concurrent flow makes sure that no dust emerges from the upper end of the kiln.

In some embodiments of the process, the rotary kiln is heated by external heating elements using electric power. In some embodiments of the process, the kiln comprises several heating zones. In some embodiments of the process, each and every heating zone is operated at a temperature in the range of from 520 to 600° C.

The process of the present disclosure comprises at least one step involving comminuting the lithium ion battery recycling material. In some embodiments, the process comprises comminuting the lithium ion battery recycling material prior to the heating step. In some embodiments, the process comprises comminuting the pyrolyzed lithium ion battery recycling material subsequent to the heating step. In some embodiments, the process comprises comminuting the lithium ion battery recycling material prior to the heating step and comminuting the pyrolyzed lithium ion battery recycling material subsequent to the heating step.

In some embodiments of the process, comminuting the lithium ion battery recycling material or the pyrolyzed lithium ion battery recycling material comprises the steps of:
I. feeding the material to a first comminuting device, e.g., a 2-shaft shredder, and comminuting the material, e.g., at a tip speed in the range of from 0.9 m/s to 1.1 m/s, to obtain first particles having a maximum diameter of 50 mm or less;
II. feeding the first particles obtained in step I) to a second comminuting device, e.g., a one-shaft shredder, and comminuting the first particles, e.g., at a tip speed in the range of from 3 m/s to 5 m/s, to obtain second particles having a maximum diameter of 20 mm or less;
III. feeding the second particles obtained in step II) to a first separating device, e.g., a vibratory or tumbler screener, to remove a first fine fraction consisting of particles having a size of <500 μm from the second particles;
IV. feeding the second particles obtained in step III) to a third comminuting device, e.g., a rotor impact mill, and comminuting the second particles, e.g., at a tip speed in the range of from 40 m/s to 60 m/s, to generate a second fine fraction consisting of particles having a size of <500 μm;
V. combining the first fine fraction and the second fine fraction.

The first and the second fine fraction, respectively, consist of particles having a size of <500 μm. In other words, all particles of the first and the second fine fraction, respectively, will pass through a sieve having a mesh width of 500 μm.

In some embodiments, step V. involves sieving the first fine fraction and the second fine fraction through a sieve having a mesh witdh of not more than 500 μm, e.g., 250 μm or less. In some embodiments, the particles remaining on the sieve are washed with water to remove residual fine fraction adhering to the particles remaining on the sieve.

In some embodiments, separating the copper composite material from the comminuted and pyrolyzed lithium ion battery recycling material involves feeding the pyrolyzed lithium ion battery recycling material to a separating device suitable to separate a mixture of particles into different fractions showing a difference in at least one physical property, e.g., having different densities, different wettabilities, or different magnetic properties. Examples of suitable separating devices include zig-zag classifiers, separating tables, air jigs, fluid bed separators, eddy current separators, electrostatic separators, magnetic separators, and any combination thereof.

In some embodiments, the comminuting devices and the separating devices used in the process are explosion proof. In some embodiments, the comminuting devices and the separating devices used in the process operate under a nitrogen blanket. Due to the concentration of graphite in dry anode scrap, dust explosions need to be prevented during the process.

### Lithium Ion Battery Recycling Material

Lithium ion batteries may be disassembled, punched, milled, for example in a hammer mill, rotor mill, and/or shredded, for example in an industrial shredder. From this kind of mechanical processing the active material of the battery electrodes may be obtained. A light fraction such as housing parts made from organic plastics and aluminum foil or copper foil may be removed, for example, in a forced stream of gas, air separation or classification or sieving.

Lithium ion batteries comprising wet cells need to be fully discharged before shredding them, otherwise there is a risk of ignition inside the shredder. Further deactivation of wet cells is affected by removal of highly flammable solvents and oxidation of highly reactive Li present in the anode.

Battery scraps may stem from, e.g., used batteries or from production waste, such as off-spec material. In some embodiments, a material is obtained from mechanically treated battery scraps, for example, from battery scraps treated in a hammer mill, a rotor mill or in an industrial shredder.

Larger parts of the battery scrap like the housings, the wiring and the electrode carrier films may be separated mechanically such that the corresponding materials may be excluded from the battery material that is employed in the disclosed process. In some embodiments, the separation is done by manual or automated sorting. For example, magnetic parts can be separated by magnetic separation non-magnetic metals by eddy-current separators. Other techniques may comprise jigs and air tables.

In some embodiments, the lithium ion battery recycling material comprises nickel, cobalt, manganese, copper, aluminum, iron, phosphorus, or combinations thereof.

In some embodiments of the process, the lithium ion battery recycling material provided comprises a copper foil and carbon, e.g., graphite coated thereon and is obtained by a process comprising: shredding a battery material, and drying the shredded battery material.

In some embodiments, a process for recycling lithium ion battery materials comprises mechanically comminuting at least one chosen from a lithium ion battery, lithium ion battery waste, lithium ion battery production scrap, lithium ion cell production scrap, lithium ion cathode active material, and combinations thereof.

In some embodiments, the lithium ion battery recycling material comprises from 1 wt.-% to 11 wt.-% copper, e.g., 2 to 10 wt.-% copper, for instance, 4 to 8 wt.-% copper in a zero oxidation state as copper foil and from 5 wt.-% to 32 wt.-% carbon, e.g., 13 to 29 wt.-% carbon, for instance, 22 to 26 wt.-% carbon; wherein each wt.-% is by total weight of the lithium ion battery recycling material.

### Copper Composite Material Production Device

The present disclosure also provides a device for producing the copper composite material. The device comprises at least two comminuting devices, a pyrolysis device, and at least one separating device configured to separate the copper composite material from comminuted and pyrolyzed lithium ion battery recycling material.

In some embodiments, the at least two comminuting devices comprise a combination of a first comminuting device, e.g., a 2-shaft shredder, and a second comminuting device, e.g., a one-shaft shredder, arranged downstream of the first comminuting device. In some embodiments, the at least two comminuting devices additionally comprise a third comminuting device, e.g., a rotor impact mill, arranged downstream of the second comminuting device.

In some embodiments, the first comminuting device is configured to work at a tip speed in the range of from 0.9 m/s to 1.1 m/s. In some embodiments, the first comminuting device is configured to produce particles having a maximum diameter of 50 mm or less.

In some embodiments, the second comminuting device is configured to work at a tip speed in the range of from 3 m/s to 5 m/s. In some embodiments, the second comminuting device is configured to produce particles having a maximum diameter of 20 mm or less.

In some embodiments, the third comminuting device is configured to work at a tip speed in the range of from 40 m/s to 60 m/s. In some embodiments, the first comminuting device is configured to produce particles having a maximum diameter of 500 μm or less.

The maximum particle diameter can easily be determined using a perforated plate or sieve having the appropriate bore size or mesh width, e.g., a perforated plate having bores of 50 mm diameter, a perforated plate having bores of 20 mm diameter, and a sieve having a mesh size of 500 μm, respectively. All particles must pass the respective perforated plate or sieve.

The device for producing the copper composite material of the present disclosure comprises a pyrolysis device. heating the lithium ion battery recycling material to a temperature of from 400° C. to 630° C. while contacting the lithium ion battery recycling material with an inert gas and with a reductive gas generated in situ by thermal decomposition of the lithium ion battery recycling material. In some embodiments, the pyrolysis device includes a supply line for supplying inert gas and/or a reductive gas to the pyrolysis space of the pyrolysis device. In some embodiments, the pyrolysis device comprises an oven, for instance, an electric oven.

In some embodiments, the pyrolysis device comprises a rotary kiln. The rotary kiln is a cylindrical tube, inclined slightly from the horizontal, which is rotated slowly about its longitudinal axis. The process feedstock is fed into the upper end of the cylinder. As the kiln rotates, material gradually moves down toward the lower end, and may undergo a certain amount of stirring and mixing.

In some embodiments, the kiln has a length in the range of from 12 to 18 m. In some embodiments, the kiln has a length in the range of from 15 to 17 m. Kiln length refers to the length of the heated zone of the kiln. Additional elements will make the overall kiln a little bit longer. In some embodiments, the inner diameter of the cylindrical tube is in the range of from 1.5 m to 2.2 m, e.g., from 1.7 m to 1.9 m.

In some embodiments, the rotary kiln features external heating elements using electric power. In some embodiments, the kiln comprises several heating zones. In some embodiments, each and every heating zone is configured to operate at a temperature in the range of from 400° C. to 650° C., e.g., from 520° C. to 600° C. In some embodiments, thermoelements are provided in each of the heating zones for measuring the temperature in the respective zone. In one embodiment, each heating zone has a length of from 0.5 m to 6 m, e.g., from 1 m to 4 m, for instance, from 1.5 m to 3 m.

In some embodiments, the kiln connects with a material exit hood at the lower end and ducts for waste gases, and features gas-tight seals at both ends of the kiln. Equipment is installed to eliminate hydrocarbons from the exhaust gas stream of the kiln before passing the exhaust gas into the atmosphere.

### Use of the Copper Composite Material

The present disclosure also provides the use of the composite material in the recovery of copper from lithium ion batteries. Due to the high copper content of the copper composite material of the present disclosure, it can directly be used to produce copper anodes for the electrolytic raffination (electrowinning) of copper. Due to its residual content of carbon, the copper composite material of the present disclosure can advantageously be used in reductive smelting processes, for instance, in an electric oven.

### Examples

### Elemental Analysis

This section describes the analytical methods used for the quantitative determination of the constituents of the copper composite material of the present disclosure.

### Metal Content

Elemental analysis was performed using a combination of acid dissolution and alkaline-borate fusion digestion with analysis by inductively coupled plasma optical emission spectrometry (ICP-OES) on an inductively coupled plasma optical emission spectrometer (e.g., Agilent 5110 ICP-OES, Agilent Technologies Germany Gmbh & Co. KG, 76337 Waldbronn, Germany).

An aliquot (e.g., about 0.2 g) of the sample material was weighed into a volumetric flask and dissolved under slight heating with 30 ml HCl. After cooling down, the insoluble residue was filtered out and incinerated together with the filter paper in a Pt crucible above an open flame. Subsequently, the residue was calcinated at about 600° C. in a muffle furnace and then mixed with 1.0 g of a K₂CO₃—Na₂CO₃/Na₂B₄O₇ flux mixture (4:1) and melted above an open flame until a clear melt was obtained. After cooling down, the melt cake was dissolved in deionized (DI) water under slight heating and 12 ml of HCl were added. Finally, the solution was joined to the initial filtered solution in the volumetric flask and topped up to its final volume with DI water. Each sample was prepared in triplicate. A blank sample was prepared in an analogous manner.

The digestion solution was analyzed by inductively coupled plasma-optical emission spectrometry (ICP-OES), using external calibration. For some samples, the digestion solution may be diluted before analysis, e.g., adapted to the concentration and calibration range of the respective analyte.

### Carbon Content

Carbon content was determined by elemental analysis in an automated analyzer (vario EL Cube, Elementar Analysensysteme GmbH, 63505 Langenselbold, Germany). The sample (2-3 mg) was weighed into a tin capsule. The capsule with the sample was combusted in a helium/oxygen atmosphere at approximately 1100° C. using copper oxide as combustion catalyst. After separation of the combustion gases via chromatography, carbon was determined as CO₂. The detection and quantification was performed via measurement of thermal conductivity using a TCD.

### Example

An intermediate lithium ion battery recycling material comprising a cathode active material was fed to a 2-shaft shredder, and comminuted at a tip speed of 1 m/s to obtain first particles having a maximum diameter of 50 mm or less. The first particles obtained were fed to a one-shaft shredder, and comminuted at a tip speed of 4 m/s to obtain second particles having a maximum diameter of 20 mm or less. A first fine fraction having a particle size of <500 μm was separated from the second particles in a vibratory screener. The second particles subsequently were fed to a rotor impact mill and comminuted at a tip speed of 50 m/s to generate a second fine fraction having a particle size of <500 μm. The first fine fraction and the second fine fraction were combined to obtain a comminuted lithium ion battery recycling material.

The comminuted lithium ion battery recycling material was fed to a rotary kiln. The temperature in the rotary kiln was ramped up from room temperature to 540° C. over a period of 50 min. The comminuted lithium ion battery recycling material dwelled at 540° C. for 10 min. The material was contacted with an inert gas and a reductive gas generated in situ by thermal decomposition of the comminuted lithium ion battery recycling material to obtain comminuted and pyrolyzed lithium ion battery recycling material comprising the copper composite material of the present disclosure.

The copper composite material was separated from the comminuted and pyrolyzed lithium ion battery recycling material using an air jig. Elemental analysis was performed on the copper composite material obtained. Triplicate determinations were carried out for each element. The composition of the copper composite material is given below:

| | | |
|---|---|---|
| Cu | (93.9 / 90.2 / 87.7) = | 91 g/100 g |
| C | (5.9 / 10.2 / 11.5) = | 9.2 g/100 g |
| Li | (0.057 / 0.086 / 0.121) = | 0.088 g/100 g |
| Mg | (0.001 / 0.002 / 0.003) = | 0.002 g/100 g |
| Al | | <0.001 g/100 g |
| Fe | (0.004 / 0.001 / 0.009) = | 0.006 g/100 g |
| Cr | (0.003 / 0.002 / 0.003) = | 0.003 g/100 g |
| Ni | (0.001 / 0.003 / 0.004) = | 0.003 g/100 g |
| Co | | <0.001 g/100 g |
| Mn | | <0.001 g/100 g |

The copper composite material had a particle size of <500 μm and was suitable to be used for the production of copper anodes by a reductive smelting process in an electric oven.

1. A process for preparing a copper composite material comprising
a) providing a lithium ion battery recycling material comprising a copper foil having graphite coated on the surface of the copper foil:
b) heating the lithium ion battery recycling material to a temperature of from 400° C. to 630° C. while contacting the lithium ion battery recycling material with an inert gas and with a reductive gas generated in situ by thermal decomposition of the lithium ion battery recycling material to obtain a pyrolyzed lithium ion battery recycling material:
c) comminuting the lithium ion battery recycling material prior to step b) and/or comminuting the pyrolyzed lithium ion battery recycling material subsequent to step b) to produce a fine fraction consisting of particles having a particle size less than 500 μm; and
d) separating the copper composite material from the comminuted and pyrolyzed lithium ion battery recycling material fine fraction consisting of particles having a particle size less than 500 μm.

2. The process of claim 1, wherein step c) comprises the steps of:
I. feeding the material to a first comminuting device and comminuting the material to obtain first particles having a maximum diameter of 50 mm or less:
II. feeding the first particles obtained in step I) to a second comminuting device and comminuting the first particles to obtain second particles having a maximum diameter of 20 mm or less:
III. feeding the second particles obtained in step II) to a first separating device to remove a first fine fraction consisting of particles having a size less than 500 μm from the second particles:
IV. feeding the second particles obtained in step III) to a third comminuting device and comminuting the second particles to generate a second fine fraction consisting of particles having a size less than 500 μm; and
V. combining the first fine fraction and the second fine fraction.

3. The process of claim 1, wherein step d) involves separating the copper composite material from the comminuted and pyrolyzed lithium ion battery recycling material fine fraction having a particle size less than 500 μm based on a difference in density.

4. The process of claim 1, wherein the lithium ion battery material comprises at least one selected from the group consisting of a lithium ion battery, lithium ion battery waste, lithium ion battery production scrap, lithium ion cell production scrap, lithium ion cathode active material, and combinations thereof.

5. The process of claim 1, wherein the lithium ion battery recycling material comprises nickel, cobalt, manganese, copper, aluminum, iron, phosphorus, or combinations thereof.

6. The process of claim 1, wherein the lithium ion battery recycling material comprises from 1 wt.-% to 11 wt.-% copper in a zero oxidation state as copper foil and from 5 wt.-% to 32 wt.-% carbon; wherein each wt.-% is by total weight of the lithium ion battery recycling material.

7. The process of claim 1, wherein the copper composite material comprises from 80 wt.-% to 99.9 wt.-% copper and from 0.1 wt.-% to 20 wt.-% carbon, based on the total weight of the copper composite material.

8. The process of claim 1, wherein the copper composite material comprises from 0.04 wt.-% to 1.0 wt.-% lithium, and/or from 0.001 wt.-% to 0.08 wt.-% nickel, and/or from 0.001 wt.-% to 0.08 wt.-% chromium, and/or from 0.001 wt.-% to 0.15 wt.-% cobalt, and/or from 0.001 wt.-% to 0.006 wt.-% iron, and/or from 0.001 wt.-% to 0.25 wt.-% manganese, and/or from 0.001 wt.-% to 0.75 wt.-% aluminum, and/or from 0.001 wt.-% to 0.002 wt.-% magnesium, based on the total weight of the copper composite material.

9. A device for producing the copper composite material of claim 1, comprising at least two comminuting devices, a pyrolysis device, and at least one separating device configured to separate the copper composite material from comminuted and pyrolyzed lithium ion battery recycling material having a particle size less than 500 μm.

10. The device of claim 9, wherein the at least two comminuting devices comprise a combination of a 2-shaft shredder and a one-shaft shredder, arranged downstream of the 2-shaft shredder.

11. The device of claim 10, further comprising a rotor impact mill arranged downstream of the 2-shaft shredder.

12. The device of claim 2, wherein the pyrolysis device comprises a rotary kiln.

13. The device of claim 12, wherein the rotary kiln features external heating elements using electric power.

14. The device of claim 2, wherein the separating device comprises zig-zag classifiers, separating tables, air jigs, fluid bed separators, eddy current separators, or a combination thereof.
